(19) United States
(12) Patent Application Publication
(10) Pub. No.: US 2014/0269180 A1
(43) Pub. Date: Sep. 18, 2014

(54) Gravity Measurements By Towed Streamers

(71) Applicant: PGS GEOPHYSICAL AS, Lysaker (NO)

(72) Inventors: Rune Tenghamn, Katy, TX (US); Einar Nielson, Bekkestua (NO)

(21) Appl. No.: 13/797,435

(22) Filed: Mar. 12, 2013

(51) Int. Cl. G01V 7/16; G01V 1/38

(52) U.S. Cl. CPC G01V 7/16; G01V 1/38
USPC 367/21; 73/382 G

(57) ABSTRACT

Techniques are described for measuring gravity using towed streamers. In an embodiment, a towed streamer apparatus comprises a plurality of micro electro-mechanical system (MEMS) sensors. One or more MEMS sensors of the plurality of MEMS sensors are configured to generate gravity measurement data. The one or more MEMS sensors transmit a digitized version of the gravity measurement data to a processing unit. In another embodiment, an apparatus is configured to receive gravity measurement data via an interface that is communicatively coupled to a plurality of MEMS sensors in at least one towed streamer. The apparatus may further be configured to combine the gravity measurement data received from the plurality of MEMS sensors to compute a target gravity measurement value and detect changes in gravity based on the target gravity measurement value.

### BACKGROUND

In the oil and gas industry, geophysical prospecting (e.g., seismic or electromagnetic surveying) is commonly used to aid in the search for and evaluation of subterranean formations. Geophysical prospecting techniques yield knowledge of the subsurface structure of the earth, which is useful for finding and extracting valuable mineral resources, particularly hydrocarbon deposits such as oil and natural gas.

One technique associated with geophysical prospecting is a seismic survey. In a marine seismic survey, a seismic signal may travel downward through a body of water overlying the surface of the earth. Seismic energy sources are used to generate the seismic signal which, after propagating into the earth, is at least partially reflected by subsurface seismic reflectors. Such seismic reflectors typically are interfaces between subterranean formations having different elastic properties, such as sound wave velocity and rock density, which lead to differences in acoustic impedance at the interfaces. The reflected seismic energy is detected and recorded by seismic sensors (also called seismic receivers) at or near the surface of the earth or at known depths an overlying body of water.

Marine seismic surveys typically employ a submerged seismic source towed by a ship and periodically activated to generate an seismic signal. The seismic source generating the signal may be of several types including, without limitation, a small explosive charge, an electric spark or arc, a marine vibrator, or a gun, such as a water gun, a vapor gun or an air gun. In many cases, the seismic source consists not of a single source element, but of a spatially-distributed array of source elements.

The appropriate types of seismic sensors are also diverse and may depend on the application. Example seismic sensors include, without limitation, particle velocity sensors and pressure sensors. Seismic sensors may be deployed by themselves, but are more commonly deployed in sensor arrays. Additionally, different types of sensors, such as pressure sensors and particle acceleration sensors, may be deployed together in a seismic survey, collocated in pairs, or pairs of arrays. One type of marine geophysical surveying utilizes long cables, known as streamers, towed behind a survey vessel to distributed the array of sensors both horizontally and vertically in the body of water.

The resulting seismic data obtained in performing the survey may be processed to yield information relating to the geologic structure and properties of the subterranean formations in the area being surveyed. For example, the processed seismic data may be processed for display and analysis of potential hydrocarbon content of these subterranean formations. One goal of seismic data processing is to extract from the seismic data as much information as possible regarding the subterranean formations in order to adequately image or otherwise characterize the geologic subsurface. Accurate characterizations of the geologic subsurface may greatly facilitate geophysical prospecting for petroleum accumulations or other mineral deposits.

Another technique for geophysical prospecting is a gravimetric survey. In a high precision gravimetric survey, a device known as a gravimeter is used to detect fractional changes in the Earth's gravitational field. Such gravimetric surveys help detect the presence of hydrocarbon and other mineral deposits as the underlying geological structures of the Earth's subsurface affect the Earth's local gravitational field.

Measurement of microgravity (μg) and sub-μg signals is a complex technical challenge, as indicated by the cost of modern gravimeters. There are currently two primary categories of gravimeters. The first category measures the local gravitational field in absolute units. Absolute gravimeters often use a weight-drop that tracks the motion of a freefalling mass in an evacuated chamber. An absolute measurement of gravity is obtained from the weight-drop mechanism. The second category of gravimeters measures the relative gravity by comparing the gravity at one point with another. A relative gravimeter is often based on zero-length springs, which balance the spring force with gravitational force. Both types of gravimeters are able to achieve resolution well below 0.1 μg and sometimes below 1 ng. Although these gravimeters are highly accurate, they are typically expensive, difficult to operate, and difficult to transport given their size and complexity.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Various embodiments are illustrated by way of example, and not by way of limitation, in the figures of the accompanying drawings and in which like reference numerals refer to similar elements and in which:

FIG. 1 is an illustration depicting a side view of an example marine seismic survey environment in which an embodiment may be implemented.

FIG. 2 is a block diagram depicting an example system architecture of a sensor for measuring acceleration including a local gravitational field, according to an embodiment;

FIG. 3 is a flowchart depicting a process for detecting changes in gravity using towed streamers, according to an embodiment; and

FIG. 4 is a block diagram depicting an example computer system upon which an embodiment may be implemented;

### DETAILED DESCRIPTION

Techniques are described herein for measuring gravity using towed streamers. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention. Various aspects of the invention are described hereinafter in the following sections:

According to embodiments described herein, micro electro-mechanical system (MEMS) sensors are used in towed streamers, such as multicomponent streamers, to perform seismic measurements, gravity measurements, and/or electromagnetic radiation (EM) measurements. The MEMS sensors may provide an inexpensive, low-power, and highly portable method to detect changes in gravity. In addition, the gravity measurements may augment the data acquired during marine geophysical (e.g., seismic or EM) surveying, which may aid in the discovery of valuable mineral resources.

In an embodiment, a towed streamer apparatus comprises a plurality of MEMS sensors. One or more of the MEMS sensors of the plurality of MEMS sensors are configured to generate gravity measurement data. The towed streamer apparatus may further comprises a cabling mechanism that interconnects the MEMS sensors with a processing unit onboard a vessel. The one or more MEMS sensors may transmit a digitized version of the gravity measurement data to the processing unit over the cabling. In some embodiments, the cabling mechanism may be optionally replaced or augmented with the use of data storage units located near the MEMS sensors, on the streamers, or otherwise separate from the vessel. The MEMS sensors may further be configured to generate particle acceleration data based on measured particle acceleration caused by a seismic signal. Thus, MEMS sensors may concurrently be used to capture both gravity and seismic measurement data, and a seismic and gravity survey may be concurrently performed.

In an embodiment, one or more MEMS sensors of the plurality of MEMS sensors comprise gravity measurement extraction logic for extracting gravity measurement data from a direct current (DC) component of an acceleration signal generated by the respective MEMS sensor. In another embodiment, one or more MEMS sensors of the plurality of MEMS sensors comprise seismic data extraction logic for extracting seismic measurement data, such as particle acceleration measurements, from the acceleration signal generated by the respective MEMS sensor.

In an embodiment, an apparatus, such as a processing unit onboard a vessel, is configured to receive gravity measurement data via an interface that is communicatively coupled to a plurality of MEMS sensors in at least one towed streamer. The apparatus may further be configured to combine the gravity measurement data received from the plurality of MEMS sensors to compute a target gravity measurement value and detect changes in gravity based on the target gravity measurement value.

In an embodiment, the apparatus is configured to extract the gravity measurement data from a DC component an acceleration signal received from one or more MEMS sensors of the plurality of MEMS sensors. The acceleration signal may further comprise seismic data, such as particle acceleration data measured by the plurality of MEMS sensors. The seismic data may include a higher frequency component of the acceleration signal

In an embodiment, the apparatus is configured to combine the gravity measurement data received from the plurality of MEMS accelerometers by averaging the gravity measurement data to reduce a noise associated with the gravity measurement data. In order to average the gravity measurement data, the apparatus may apply delta-sigma modulation to a group of gravity measurements received from a group of MEMS accelerometers of the plurality of MEMS accelerometers. Delta-sigma modulation may generate an output that converges to an average gravity measurement value based on the input group of gravity measurements. After the averaging has converged to a constant value, changes in a local gravitational field may be detected if the target gravity measurement value changes by a threshold amount.

In an embodiment, the apparatus may be used in a time-lapse survey to detect changes to a particular geological location over time.

In an embodiment, the apparatus may be configured to characterize subterranean geological features based on gravity measurement data and at least one of seismic measurement data and EM measurement data. In another embodiment, the apparatus may be configured to characterize subterranean geological feature based solely on the gravity measurement data.

In an embodiment, MEMS sensors are coupled to one or more towed streamers. One or more of the MEMS sensors are configured to measure gravity and to generate gravity measurement data. In particular, the one or more MEMS sensors support frequencies down to DC (i.e., zero or near-zero frequency). The DC information generated by each MEMS sensor may then be used to detect changes in gravity, as described in further detail below.

FIG. 1 is an illustration of a side view of an example marine survey environment in which one or more towed streamers 110 with MEMS sensors may be deployed. Each streamer of the one or more streamers 110 trails behind vessel 100 as the vessel moves forward (in the direction of arrow 102), and each streamer includes multiple seismic sensors 114. The survey equipment may further include one or more diverters 118 and programmable depth controllers to direct each of the one or more streamers 110 out to an operating offset distance from the vessel's path and down to an operating depth.

Each of the one or more streamers 110 may be up to several kilometers long, and are usually constructed in sections 25 to 100 meters in length that include groups of up to 35 or more uniformly spaced seismic sensors. Each streamer includes electrical or fiber-optic cabling for interconnecting sensors 114 and the seismic equipment on vessel 100. Data may be digitized near sensors 114 and transmitted to vessel 100 through the cabling. Data may also be retained proximate the sensors 114 for delayed downloading and/or processing.

As depicted in FIG. 1, survey vessel 100 also tows a source 112. In some embodiments, source 112 may be towed by a second survey vessel (not shown). Source 112 may be an impulse source, an electric field transmitter, or a vibratory source. Sensors 114 include a plurality of MEMS sensors as described herein. Sensors 114 may further include other seismic sensors, such as hydrophones, geophones, and/or EM receivers. Source 112 and sensors 114 typically deploy below the ocean's surface 104. Processing equipment aboard the vessel may control the operation of the source and MEMS sensors and may record the acquired data.

Survey vessel 100 may tow the one or more streamers 110 to perform a gravity survey according to the techniques described herein. Survey vessel 100 may also concurrently perform a seismic survey and or an EM survey, depending on the particular implementation. The one or more surveys provide data for imaging below the ocean floor 108, including subsurface structures such as structure 106. Certain gravity, seismic, and/or EM characteristics of recorded data, such as a slight change in gravity, are indicative of oil and/or gas reservoirs.

To image the subsurface structure 106, source 112 may emit seismic signals 116 that are reflected where there are changes in acoustic impedance contrast due to subsurface structure 106 (and other subsurface structures). The reflected signals are detected by a pattern of sensors 114. By recording, among other things, the elapsed time for the seismic signals 116 to travel from source 112 to subsurface structure 106 to sensors 114, an image of subsurface structure 106 can be obtained after appropriate data processing. In addition, to the data acquired from seismic signals 116, sensors 114 also detect absolute or relative gravity based on the measurements of the included MEMS sensors. In another embodiment, source 112 may emit EM signals into subsurface structure 106. Sensors 114 may measure the electric and/or magnetic fields induced in subsurface structure 106 in response to the emitted EM signals.

The architecture of the MEMS sensor may vary, depending on the particular implementation, and the approaches described herein are not limited to any particular MEMS architecture. FIG. 2 is a block diagram depicting an example system architecture of a MEMS sensor, according to an embodiment. System architecture 200 generally comprises accelerometer 202, analog read-out electronics 204, analog to digital converter (ADC) 206, and signal processing logic 208.

Accelerometer 202 senses acceleration that is applied to the MEMS sensor such as particle acceleration from the reflected signals and an acceleration caused by the Earth's local gravitational field. For example, accelerometer 202 may comprise a cantilever beam with a seismic mass or some other sensing mechanism. Accelerometer 202 may also include multiple axes to capture out-of-plane measurements. In an example embodiment, the seismic mass is suspended on multiple cantilever beams allowing for sensing on three orthogonal axes. In an example embodiment, MEMS system architecture 200 comprises a plurality of individual accelerometers for sensing acceleration on the different planes. An accelerometer that can sense acceleration on three orthogonal planes is herein referred to as 3-axis accelerometer.

Analog read-out electronics 204 convert the detected acceleration into an analog electrical signal. The analog signal carries information comprising acceleration measurement values according to the input acceleration sensed by accelerometer 202. The analog signal may be generated, for example, in response to the seismic mass deflecting from a neutral position caused by the input acceleration. Accordingly, the acceleration information carried by the analog signal may comprise both gravity data and particle acceleration data. ADC 206 converts the analog signal received from analog read-out electronics 204 to a digital, discrete time signal.

Signal processing logic 208 comprises gravity data extraction logic 210 and seismic data extraction logic 212. Gravity data extraction logic 210 processes the discrete-time signal to extract the gravity measurement data from the acceleration information, and seismic data extraction logic 212 processes the discrete-time signal to extract the particle acceleration data. Signal processing logic 208 outputs extracted gravity measurement data and particle acceleration data to the processing equipment aboard the vessel via the cabling included in the streamer. In another embodiment, the gravity and seismic data extraction may be performed by the processing equipment aboard the vessel. In such an embodiment, ADC 206 or signal processing logic 208 outputs the digital acceleration signal without extracting the gravity and/or particle acceleration data. In yet another embodiment, the extraction may be performed on the analog signal before conversion to a digitalized format by ADC 206.

In an embodiment the gravity extraction logic 210 and the seismic data extraction logic 212 are on-chip with other elements in system architecture 200. Accordingly, each MEMS sensor provides a one-chip solution for measuring both seismic data and gravity data. In an alternative embodiment, each MEMS sensor only comprises logic for measuring gravity data.

FIG. 3 is a flowchart depicting a process for detecting changes in gravity using towed streamers, according to an embodiment. In step 302 one or more streamers that include a plurality of MEMS sensors are deployed behind a vessel such as depicted in FIG. 1. The manner in which the MEMS sensors are grouped and distributed across the one or more streamers may vary from implementation to implementation. For example, the MEMS sensors may be evenly or arbitrarily spaced. The streamers may have the same number of MEMS sensors, some streamers may have more MEMS sensors than others, or some streamers may not have any MEMS sensors. The streamers may also include other seismic sensors, such as hydrophones, for collecting other seismic data.

The diverters and programmable depth controllers maintain the operating offset distance and operating depth of the MEMS sensors to help control instrument drift. In another embodiment, the streamers and/or MEMS sensors are equipped with temperature control systems to maintain a constant temperature. Keeping the temperature of the MEMS sensors constant within a few degrees also helps minimize instrument drift for more accurate gravity measurements.

In step 304, MEMS sensors generate acceleration measurement data while the streamers are being towed. In an embodiment, one or more MEMS sensors measure gravity as the streamers are being towed and generate gravity measurement data. In another embodiment, the MEMS sensors record particle acceleration data caused by the seismic signals. The MEMS sensors may concurrently capture the gravity measurements data and seismic data, such as particle acceleration. The local gravitational field manifests as a DC component of the acceleration signal generated from the accelerometer, while the particle acceleration typically manifests as a higher frequency component of the signal. The DC component is a zero or near-zero frequency portion of the acceleration signal and represents a constant or near-constant acceleration (i.e., gravity) applied to accelerometer 202. A MEMS sensor may extract this DC component to isolate the gravity measurement data from the particle acceleration data. The remaining, higher-frequency component may then be filtered to further extract seismic data. The MEMS sensors may then digitize and send each component separately to the onboard processing logic. Alternatively, the MEMS sensor may send a digitized version of the entire acceleration signal to the onboard processing logic, which may perform the extraction process. In another alternative, the MEMS sensor may retain the acceleration data for delayed downloading and processing.

In step 306, MEMS sensors transmit the acceleration measurement data to processing equipment onboard the vessel. Data transmission may occur continuously while the MEMS sensors are generating acceleration measurement data as the streamers are being towed. As indicated above, the MEMS sensors may transmit isolated components of the acceleration separately over the cabling to onboard processing equipment or may transmit all measured acceleration data as a composite signal, depending on the implementation.

In step 308, processing equipment, such as that onboard the vessel, receives the acceleration measurement data from one or more of the MEMS sensors. If not already performed by signal processing logic 208 on the MEMS sensor, then at step 308 the processing equipment extracts the gravity measurement from a DC component of the received measurement data.

In some cases, unintentional DC components may compromise the integrity of the gravity measurements. For example, cap wafer deflection typically creates a DC component of about −140 decibels relative to full scale. Other sources of possible DC offset include capacitive mismatch of upper and lower electrodes in the MEMS geometry, mismatch of parasitic capacitances of the traces between the MEMS accelerometer and the readout circuit, offset in the readout circuit, and mismatch of parasitic resistances of tracks from the regulator to the electrodes. In an embodiment, onboard processing equipment at step 308 and/or one or more MEMS sensors at step 304 apply a compensation signal to compensate for unintentional DC offset. The compensation signal may be calibrated according to the sources of DC offset, which may vary from implementation to implementation. Although the compensation signal may not cancel all sources of DC offset, as long as the relative DC accuracy of target gravity measurement signal over a particular period of time is approximately 0.1 μg, changes in the Earth's gravitational field can be accurately detected.

In step 310, the processing equipment combines the gravity measurement data to compute an average gravity measurement value. In order to combine the gravity measurement data, processing equipment may average the incoming gravity measurements from a grouping of the plurality of MEMS sensors to converge to a constant gravity value. In an embodiment, this step includes using delta-sigma modulation, also known as sigma-delta modulation, to average the gravity measurements of the MEMS sensors. Delta-sigma modulation may improve the signal to noise ratio of the combined final gravity measurement value based on the technique of oversampling. In particular, a more accurate representation of a low-frequency input signal (i.e., gravity) may be obtained by a delta sigma converter by averaging many low-resolution, less-accurate samples (i.e., the gravity measurements from one or more individual MEMS sensors in the group).

In an example implementation, ten to twenty streamers may be deployed with each streamer having several thousand 3-axis accelerometers over a twelve kilometer length. The sensors may be grouped in any suitable way, such as by location on the streamers, to obtain average gravity measurements according to step 310. For example, if the several thousand sensors are divided into groups of 100, one or more of the groups generate an averaged gravity measurement from the MEMS sensors in the group. A delta-sigma converter may be used to average the 100 gravity measurement signals to give a single output value representing the average or final gravity measurement value for the group. The delta-sigma converter may shape the noise of the output signal by applying a delta-sigma loop filter. The delta-sigma converter may reduce the amount of noise by the square root of the number of samples, which in the present example is the square root of 100. Accordingly, the signal to noise ratio may be improved by a factor of ten, which increases the resolution of the overall gravity measurement. Although each individual sensor may not have the resolution performance to accurately detect changes in gravity, the noise-shaping of the delta-sigma modulation may be run for long enough to average out any long-period 1/f and other noise sources to obtain an acceptable gravity measurement. For example, quantization noise density at DC for frequencies up to about 100 Hertz is about thirty ng per root Hertz in a typical scenario. In order to have a relative DC accuracy over a few hours of about 0.1 μg, an acceptable noise bandwidth is less than about 3 Hertz. Such a noise bandwidth may be attained through applying the compensation signal and using the noise shaping techniques of delta-sigma modulation described herein.

In step 312, a change in gravity is detected from the average gravity measurement value. Once the delta-sigma conversion output has converged to a constant value, the change in gravity may be detected if the average value changes or differs from neighboring groups by a threshold amount. For example, if the output value changes or differs from neighboring groups by an amount of 0.1 μg or more, this event may be captured and/or displayed by the onboard processing logic. Such an event may also be used in combination with seismic data, such as particle velocity and acceleration, or EM measurement data, such as the electrical resistivity of subsurface rock, to classify the geological properties of the local subsurface of the Earth where the event was captured. For example, the processing logic may analyze the combination of gravity and seismic data to characterize the depth and density of the subsurface layers. The threshold amount which triggers a detected change may vary from implementation to implementation and may be fine-tuned based on the resolution accuracy of the average gravity measurement data.

The towed streamers described herein may be used in a time-lapse survey to detect changes in gravity to the same region over a period of time. In such a survey, average gravity measurements may be acquired by the towed streamers over the same spatial reference at different times. For example, steps 302 to 310 may be performed at a particular location beginning at a first point in time. These steps may then be repeated at the same location beginning at one or more different points in time, such as a different days, months, and years.

In an embodiment, the parameters and systems used to acquire the gravity measurements at the different points in time may be identical or near-identical to ensure the accuracy of the gravity measurement data. For instance, the number of streamers, MEMS sensors, and the manner in which the MEMS sensors are grouped may be identical. The operating depth and distance, the temperature of the MEMS sensors, and other parameters may also be identical or near-identical.

The average gravity measurements acquired at the different times are compared at step 312 to detect changes in gravity to a particular spatial region over time.

According to one embodiment, the processing equipment described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that illustrates an example computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. Although bus 402 is illustrated as a single bus, bus 402 may comprise one or more buses. For example, bus 402 may include without limitation a control bus by which processor 404 controls other devices within computer system 400, an address bus by which processor 404 specifies memory locations of instructions for execution, or any other type of bus for transferring data or signals between components of computer system 400.

An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for detecting changes in gravity comprising:
receiving gravity measurement data from a plurality of micro electro-mechanical system (MEMS) sensors that are coupled to at least one towed streamer;
combining the gravity measurement data received from the plurality of MEMS sensors to compute a target gravity measurement value;
detecting changes in gravity based on the target gravity measurement value;
wherein the method is performed by one or more computing devices.

2. The method of claim 1, further comprising extracting the gravity measurement data from a direct current component of an acceleration signal received from one or more MEMS sensors from the plurality of the MEMS sensors.

3. The method of claim 2, wherein the acceleration signal further comprises particle acceleration data measured by the plurality of MEMS sensors.

4. The method of claim 1, wherein combining the gravity measurement data received from the plurality of MEMS accelerometers comprises averaging the gravity measurement data to reduce a noise associated with the gravity measurement data.

5. The method of claim 4, wherein averaging the gravity measurement data comprises applying delta-sigma modulation to the gravity measurement data to converge to the target gravity measurement value.

6. The method of claim 1, wherein detecting changes in gravity based on the target gravity measurement value comprises determining if the target gravity measurement value has changed by a threshold amount; and determining that a local gravitational field has changed if the target gravity measurement value has changed by the threshold amount.

7. The method of claim 1, wherein the gravity measurement data is received during a time-lapse survey, wherein detecting changes in gravity based on the target gravity measurement value comprises detecting changes to a particular geological location over time.

8. An apparatus comprising:
an interface communicatively coupled to a plurality of micro electro-mechanical system (MEMS) sensors in at least one towed streamer, the interface configured to receive gravity measurement data from the plurality MEMS sensors;
one or more processors;
one or more storage media storing instructions, which, when processed by the one or more processors, cause:
combining the gravity measurement data received from the plurality of MEMS sensors to compute a target gravity measurement value;
detecting changes in gravity based on the target gravity measurement value.

9. The apparatus of claim 8 wherein the instructions, when processed, further cause the apparatus to perform: extracting the gravity measurement data from a direct current component of an acceleration signal received from one or more MEMS sensors of the plurality of MEMS sensors.

10. The apparatus of claim 9, wherein the acceleration signal further comprises particle acceleration data measured by the plurality of MEMS sensors.

11. The apparatus of claim 8, wherein instructions for combining the gravity measurement data received from the plurality of MEMS accelerometers comprise instructions for averaging the gravity measurement data to reduce a noise associated with the gravity measurement data.

12. The apparatus of claim 11, wherein instructions for averaging the gravity measurement data comprise instructions for applying delta-sigma modulation to the gravity measurement data to converge to the target gravity measurement value.

13. The apparatus of claim 8, wherein instructions for detecting changes in gravity based on the target gravity measurement value comprise instructions for determining if the target gravity measurement value has changed by a threshold amount; and determining that a local gravitational field has changed if the target gravity measurement value has changed by the threshold amount.

14. The apparatus of claim 8, wherein the interface receives gravity measurement data during a time-lapse survey, wherein instructions for detecting changes in gravity based on the target gravity measurement value comprise instructions for detecting changes to a particular geological location over time.

15. An apparatus comprising:
one or more streamers; and
a plurality of micro electro-mechanical system (MEMS) sensors disposed on the one or more streamers, wherein one or more MEMS sensors of the plurality of MEMS sensors are configured to generate gravity measurement data.

16. The apparatus of claim 15, further comprising:
a cabling mechanism for interconnecting the plurality of MEMS sensors with a processing unit, wherein the one or more MEMS sensors of the plurality of MEMS sensors transmit a digitized version of the gravity measurement data to the processing unit.

17. The apparatus of claim 15, wherein the processing unit is disposed onboard a vessel that tows the one or more streamers.

18. The apparatus of claim 15, wherein the one or more MEMS sensors of the plurality of MEMS sensors are further configured to generate particle acceleration data based on measured particle acceleration caused by a seismic signal.

19. The apparatus of claim 15, wherein the one or more MEMS sensors of the plurality of MEMS sensors comprise gravity measurement extraction logic for extracting the gravity measurement data from a zero or near-zero frequency component of an acceleration signal generated by the respective MEMS sensor.

20. The apparatus of claim 19, wherein the one or more MEMS sensors comprises seismic data extraction logic for extracting seismic measurement data from the acceleration signal generated by the respective MEMS sensor.

21. The apparatus of claim 18, wherein the seismic measurement data includes particle acceleration data.

22. The apparatus of claim, wherein the processing unit is configured to:
receive the gravity measurement data from the plurality of MEMS sensors over the cabling;
combine the gravity measurement data received from the plurality of MEMS sensors to compute a target gravity measurement value;
detect changes in gravity based on the target gravity measurement value.

23. A method of geophysical surveying comprising:
detecting gravity measurement data with a plurality of micro electro-mechanical system (MEMS) sensors that are coupled to at least one towed streamer:
combining the gravity measurement data to compute a target gravity measurement value; and
detecting changes in gravity based on the target gravity measurement value.

24. The method of claim 23, further comprising:
combining the target gravity measurement value with seismic data;
determining one or more geological properties of a subsurface based on combining the target gravity measurement value with the seismic data.

25. The method of claim 23, further comprising:
combining the target gravity measurement value with electromagnetic measurement (EM) data;
determining one or more geological properties of a subsurface based on combining the target gravity measurement value with the EM data.
